(19) United States
(12) Patent Application Publication
(10) Pub. No.: US 2015/0056718 A1
(43) Pub. Date: Feb. 26, 2015

(54) DUAL SYRINGE

(71) Applicants: Sylvia Maria Cuttino, Beaufort, SC (US); Robin Williams Armes, Beaufort, SC (US)

(72) Inventors: Sylvia Maria Cuttino, Beaufort, SC (US); Robin Williams Armes, Beaufort, SC (US)

(21) Appl. No.: 14/467,731

(22) Filed: Aug. 25, 2014

Related U.S. Application Data
(60) Provisional application No. 61/869,475, filed on Aug. 23, 2013.

(51) Int. Cl. G01N 1/14

(52) U.S. Cl. CPC G01N 1/14
USPC 436/180; 422/514

(57) ABSTRACT

A dual syringe is provided. The dual syringe includes a first barrel and a second barrel. The first barrel may slidably engage within the second barrel. A first chamber and a second chamber may be formed in the first barrel. A first plunger may be slidably engaged within the first chamber and a second plunger may be slidably engaged within the second chamber. A first valve may be attached in between the first chamber and a mixing chamber of the second barrel 26. Further, a second valve may be attached in between the second chamber and the mixing chamber. Therefore, a first liquid may be pushed from the first chamber into the mixing chamber by the first plunger, and a second liquid may be pushed from the second chamber into the mixing chamber. Then, the mixed liquids may be pushed out of the mixing chamber by both of the first and second plungers.

### CROSS-REFERENCE TO RELATED APPLICATION

This application claims the benefit of priority of U.S. provisional application No. 61/869,475, filed Aug. 23, 2013, the contents of which are herein incorporated by reference.

### BACKGROUND OF THE INVENTION

The present invention relates to a syringe and, more particularly, to a dual syringe.

A syringe is a simple pump consisting of a plunger that fits tightly in a tube. The plunger can be pulled and pushed along inside a cylindrical tube (called a barrel), allowing the syringe to take in and expel a liquid or gas through an orifice at the open end of the tube. With the current red blood cell tagging process, five syringes are needed. This method exposes a great risk for needle sticks and contamination.

As can be seen, there is a need for an improved syringe to simplify the procedure of red blood cell tagging as well as simplifying other procedures.

### SUMMARY OF THE INVENTION

In one aspect of the present invention, a dual syringe comprises: a first barrel comprising a base and a sidewall forming opening leading into an internal chamber; a divider separating the internal chamber into a first chamber and a second chamber; a first plunger sized to slidably engage within the first chamber and a second plunger sized to slidably engage within the second chamber; a first valve through the base within the first chamber and a second valve through the base within the second chamber; and a second barrel comprising a base and a sidewall forming an opening leading into a mixing chamber, wherein the first barrel slidably engages within the second barrel.

In another aspect of the present invention, a dual syringe comprises: a first barrel comprising a first end comprising a base and a second end comprising an opening leading into an internal chamber; a divider extending from the base and separating the internal chamber into a first chamber and a second chamber; a first plunger sized to slidably engage within the first chamber and a second plunger sized to slidably engage within the second chamber; a first pressure activated valve through the base within the first chamber and a second pressure activated valve through the base within the second chamber; a first shaft extending from the first plunger and a second shaft extending from the second plunger, wherein each shaft comprises an end sized to cover and seal one of the pressure activated valves; and a second barrel comprising a first end comprising a base and a second end comprising an opening leading into a mixing chamber, wherein the first barrel slidably engages within the second barrel.

These and other features, aspects and advantages of the present invention will become better understood with reference to the following drawings, description and claims.

### BRIEF DESCRIPTION OF THE DRAWINGS

FIG. 1 is a perspective view of the present invention with two different liquids within two separate chambers;

FIG. 2 is a perspective view of the present invention with a first plunger engaged within a first chamber;

FIG. 3 is a perspective view of the present invention with a first and a second plunger engaged within a first and a second chamber; and

FIG. 4 is a perspective view of the present invention with a first barrel engaged within a second barrel.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a dual syringe. The dual syringe of the present invention may streamline the process of red blood cell tagging. The two compartments of the present invention may contain the tagging agents. Using the present invention, only two needles may be needed for performing the process. One may be used for adding blood and the other for adding Technetium 99m from the dual syringe. The present invention may include a 10 ml syringe that allows containment of two different components use for blood tagging. The dual syringe may then lock back into a single syringe for administration of blood. In certain embodiments, a protective wrapping for light sensitive materials may be added.

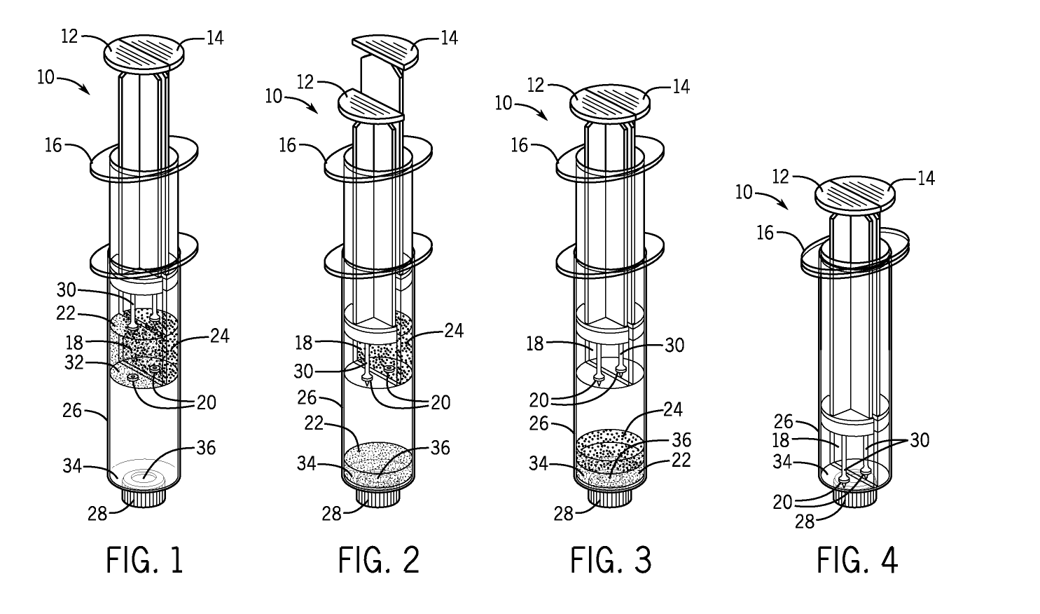

Referring to FIGS. 1 through 4, the present invention includes a dual syringe 10. The dual syringe 10 includes a first barrel 16 and a second barrel 26. The first barrel 16 may slidably engage within the second barrel 26. A first chamber and a second chamber may be formed in the first barrel 16. A first plunger 12 may be slidably engaged within the first chamber and a second plunger 14 may be slidably engaged within the second chamber. A first valve 20 may be attached in between the first chamber and a mixing chamber of the second barrel 26. Further, a second valve 20 may be attached in between the second chamber and the mixing chamber. Therefore, a first liquid 22 may be pushed from the first chamber into the mixing chamber by the first plunger 12, and a second liquid 24 may be pushed from the second chamber into the mixing chamber by the second plunger 14. Then, the mixed liquids 22, 24 may be pushed out of the mixing chamber by both of the first and second plungers 12, 14.

The first barrel 16 of the present invention may include a sidewall having a first end and a second end. The first end may include a base 32 and the second end may form an opening leading into an internal chamber. The first barrel 16 may be shaped and sized similar to a barrel of a syringe. A divider 18 may attached to the first barrel 16 within the internal chamber. The divider 18 may extend vertically from the base 32, thereby forming vertical first and second chambers. The first valve 20 may be disposed through the base 32 within the first chamber, and the second valve 20 may be disposed through the base 32 within the second chamber.

The first plunger 12 and the second plunger 14 may fit within the internal chamber of the first barrel 16. As mentioned above, the first plunger 12 may be slidably engaged within the first chamber and a second plunger 14 may be slidably engaged within the second chamber. In certain embodiments, the tops of the plungers 12, 14 may be substantially flat and may be pressed. By pressing on the first and second plunger 12, 14, a rubber end attached to the plungers 12, 14 may force liquid through the valves 20.

In certain embodiments, a first shaft 30 may extend from the first plunger 12 and a second shaft 30 may extend from the second plunger 14. Each shaft 30 may include a rubber end sized to cover and seal one of the valves. Therefore, when the first and/or second liquid 22, 24 has been pushed through the valves, the shaft 30 may prevent the liquid 22, 24 from coming back into the first and second chambers.

As mentioned above, the present invention further includes a second barrel 26. The second barrel 26 includes a sidewall having a first end and a second end. The first end may include a base 34 and the second end may form an opening leading into a mixing chamber. The second barrel 26 may be shaped and sized similar to a barrel of a syringe, however having dimensions larger than the first barrel 16 so that the first barrel 16 may fit within the second barrel 26. The second barrel 26 may also include a pressure activated valve 36 through the base 34. In certain embodiments, a removable rubber stopper 28 may be attachable to the pressure activated valve 36. A needle or a tube may be attached to the removable rubber stopper 28.

The first valve 20 and the second valve 20 may be any valve for regulating the movement of liquid from the internal chamber to the mixing chamber. In certain embodiments, the first and a second valves 20 may be a pressure activated valve, or a check valve. In certain embodiments, the valve 20 may include a thin film separating the internal chamber from the mixing chamber. In such embodiments, the first and second shafts 30 may include a pointed tip, such as a pin tip. Therefore, the user may press down on the first and second plungers 12, 14 and pierce the thin film, thereby opening the valves 20 and pushing the liquid from the internal chamber to the mixing chamber.

A method of using the present invention may include the following. The dual syringe 10 described above may be provided. A first liquid 22 may be placed within the first chamber and a second liquid 24 may be placed within the second chamber. The user may first press on the first plunger 12 towards the base 32 of the first barrel 16, thereby forcing the first liquid through the first valve 29 and into the mixing chamber. The first liquid 22 may be injected into a user by continuing to press down on the first plunger 12. Alternatively, the user may mix the liquids 22, 24 by pressing press on the second plunger 14 towards the base 32 of the first barrel 16, thereby forcing the second liquid through the first valve 20 and into the mixing chamber forming the mixture of the liquids 22, 24. The first and second plungers 12, 14 may then be pressed together towards the base 36 of the second barrel 26, thereby forcing the mixture out of the second barrel 26.

It should be understood, of course, that the foregoing relates to exemplary embodiments of the invention and that modifications may be made without departing from the spirit and scope of the invention as set forth in the following claims.

What is claimed is:

1. A dual syringe comprising:
a first barrel comprising a base and a sidewall forming opening leading into an internal chamber;
a divider separating the internal chamber into a first chamber and a second chamber;
a first plunger sized to slidably engage within the first chamber and a second plunger sized to slidably engage within the second chamber;
a first valve through the base within the first chamber and a second valve through the base within the second chamber; and
a second barrel comprising a base and a sidewall forming an opening leading into a mixing chamber, wherein the first barrel slidably engages within the second barrel.

2. The dual syringe of claim 1, wherein the divider is attached to and extends from the base of the first barrel.

3. The dual syringe of claim 2, wherein the divider is a vertical divider, thereby forming vertical first and second chambers.

4. The dual syringe of claim 1, wherein the first valve and the second valve are each pressure activated valves.

5. The dual syringe of claim 1, further comprising a first shaft extending from the first plunger and a second shaft extending from the second plunger, wherein each shaft comprises an end sized to cover and seal one of the valves.

6. The dual syringe of claim 5, wherein the ends of the first and second shafts comprise a pointed tip, wherein the first and second valves comprise a thin film puncturable by the pointed tips.

7. The dual syringe of claim 1, wherein the second barrel further comprises a pressure activated valve through the base.

8. The dual syringe of claim 7, further comprising a removable rubber stopper attachable to the pressure activated valve of the second barrel.

9. A method of using the dual syringe of claim 1 comprising the steps of:
placing a first liquid in the first chamber and a second liquid in the second chamber;
pressing the first plunger towards the base of the first barrel, thereby forcing the first liquid through the first valve and into the mixing chamber;
pressing the second plunger towards the base of the first barrel, thereby forcing the second liquid through the second valve and into the mixing chamber forming a mixture; and
pressing the first and second plunger together towards the base of the second barrel, thereby forcing the mixture out of the second barrel.

10. A dual syringe comprising:
a first barrel comprising a first end comprising a base and a second end comprising an opening leading into an internal chamber;
a divider extending from the base and separating the internal chamber into a first chamber and a second chamber;
a first plunger sized to slidably engage within the first chamber and a second plunger sized to slidably engage within the second chamber;
a first valve through the base within the first chamber and a second valve through the base within the second chamber;
a first shaft extending from the first plunger and a second shaft extending from the second plunger, wherein each shaft comprises an end sized to cover and seal one of the pressure activated valves; and
a second barrel comprising a first end comprising a base and a second end comprising an opening leading into a mixing chamber, wherein the first barrel slidably engages within the second barrel.

11. The dual syringe of claim 10, wherein the second barrel further comprising a pressure activated valve through the base.

12. The dual syringe of claim 11, further comprising a removable rubber stopper attached to an outer surface of the base of the second barrel, wherein the stopper is attached to the valve of the second barrel.

13. The dual syringe of claim 10, wherein the divider is a vertical divider, thereby creating vertical first and second chambers.

14. The dual syringe of claim 10, wherein the ends of the first and second shafts comprise a pointed tip, wherein the first and second valves comprise a thin film puncturable by the pointed tips.

15. The dual syringe of claim 10, wherein the first valve and the second valve are each pressure activated valves
